(19) United States
(12) Patent Application Publication
(10) Pub. No.: US 2004/0066333 A1
(43) Pub. Date: Apr. 8, 2004

(54) Active antenna with interleaved arrays of antenna elements

(75) Inventors: Mano D. Judd, Rockwall, TX (US); Thomas A. Bachman II, Darlington, MD (US)

Correspondence Address: WOOD, HERRON & EVANS, LLP, 2700 CAREW TOWER, 441 VINE STREET, CINCINNATI, OH, 45202, US

(73) Assignee: Andrew Corporation, Orland Park, IL

(21) Appl. No.: 10/256,860

(22) Filed: Sep. 27, 2002

(51) Int. Cl. H01Q 21/00

(52) U.S. Cl. 343/700 MS; 343/853; 343/810

(57) ABSTRACT

An antenna has multiple arrays of radiating elements and includes a plurality of single channel power amplifiers, with each amplifier electrically connected with an array. The radiating elements of the arrays are interleaved so that radiation from the arrays combines at a distance from the antenna.

### FIELD OF THE INVENTION

This invention relates generally to antennas, and more particularly to antennas incorporating arrays of antenna elements.

### BACKGROUND OF THE INVENTION

As the data rate in a digitally modulated wireless communication system is increased, a corresponding increase in the output power of the signals radiated by a tower-mounted antenna is typically required to effectively communicate with subscribers within a given service area. Thus, migrating an existing system to a higher data rate often requires more output power from the amplifiers used in the system and/or a reduction or elimination of losses associated with components in the system. However, it has been found that certain known modulation schemes may be better suited for migrating to higher data rates than others as the ability to increase output power differs for various modulation schemes.

For example, in systems using code-division multiple access (CDMA or WCDMA) modulation, a single multi-carrier amplifier may be used for several different carriers. In order to provide the additional radiated output power associated with higher data rates, a single, large multi-carrier amplifier is used in the system. Thus, a multi-carrier amplifier allows the task of amplifying the broad frequency spectrum associated with several carriers using a single, high power linear amplifier. As a result, multi-carrier amplifiers configured for use in CDMA systems may be capable of providing the additional radiated output power associated with higher data rates.

In other environments, comparable results may be obtained through a reduction of losses. For example, in systems using time-division multiple access (TDMA) modulation, a tunable cavity combiner, which typically has a relatively low insertion loss, may often be used to reduce losses, thereby requiring less gain from any amplifiers used therewith, and possibly providing the additional radiated output power associated with a higher data rates and multiple carriers.

Other modulation schemes, however, are not as well suited to increasing output power and carriers merely through the use of additional amplifiers dedicated to individual carriers or low insertion loss combiners. For example, unlike CDMA and TDMA systems, Global System for Mobile (GSM) communications systems use frequency hopping techniques to minimize interference between adjacent channels. Thus, unlike in a CDMA or TDMA system, the active carriers in GSM system may dynamically change from time to time, a process commonly referred to as frequency hopping. Therefore, amplifiers and combiners used with a GSM system may require greater bandwidth than those used in a CDMA or TDMA system to allow for frequency hopping.

Due to the requirement of greater bandwidth, multi-carrier power amplifiers and tuned cavity combiners are not as well suited for use in GSM systems. In particular, constructing a multi-carrier amplifier wherein each amplifier is capable of uniformly amplifying the bandwidth associated with frequency hopping in a GSM system can be expensive. Similarly, constructing a wide bandwidth tuned cavity combiner with low insertion loss across the band is difficult since the cavity is often optimized for a particular frequency to achieve low insertion loss. As a result, GSM systems often use hybrid combining due to bandwidth considerations associated with frequency hopping. However, a power loss of 3 dB is typically associated with hybrid combining, requiring even more gain and output power from amplifiers used therewith.

Recently, a new modulation technique was released for GSM communications referred to as Enhanced Data rates for Global Evolution, or EDGE. EDGE allows network operators to use existing GSM infrastructure to provide data, multimedia, and application services at rates of up to 384 kilobits per second (kbps), more than three times the speed of GSM. A difficulty encountered using existing GSM infrastructure to provide EDGE services is that EDGE modulation requires an additional 3-4 decibels (dB) more radiated power output than typical GSM systems.

In order to provide the additional gain necessary in providing higher data rates services, such as EDGE, some network operators have recognized the losses associated with hybrid combining and have resorted to using GSM multi-carrier power amplifiers. However, multi-carrierl power amplifiers for such systems may be prohibitively expensive for some service providers in adapting their systems to high data rate modulation schemes, such as EDGE.

Thus, there is a need for an economical alternative that allows network operators to provide higher data rate services, such as EDGE, by affording additional gain and power through avoiding the losses associated with combiners typically used in such systems, and without resorting to using expensive multi-carrier amplifiers.

### BRIEF DESCRIPTION OF THE DRAWINGS

The accompanying drawings, which are incorporated in and constitute part of this specification, illustrate embodiments of the invention and, together with the detailed description given below, serve to explain the principles of the invention.

FIG. 1 is a block diagram of an antenna configured for free space combining in accordance with principles of the present invention,

FIG. 2 is schematic diagram of a second embodiment of an antenna in accordance with principles of the present invention.

FIG. 3 is a schematic diagram of a third embodiment of an antenna in accordance with principles of the present invention.

FIG. 4 is a schematic diagram of a fourth embodiment of an antenna in accordance with principles of the present invention.

FIG. 5 is a schematic diagram of a fifth embodiment of an antenna in accordance with principles of the present invention.

### DETAILED DESCRIPTION OF THE DRAWINGS

The present invention provides an economical alternative that allows network operators to provide higher data rate services, such as EDGE, by avoiding the losses associated with combiners typically used in telecommunication systems, and without resorting to expensive multi-carrier amplifiers. To this end, and in accordance with principles of the present invention, free space combining is used to provide the additional radiated output power desired with higher data rates.

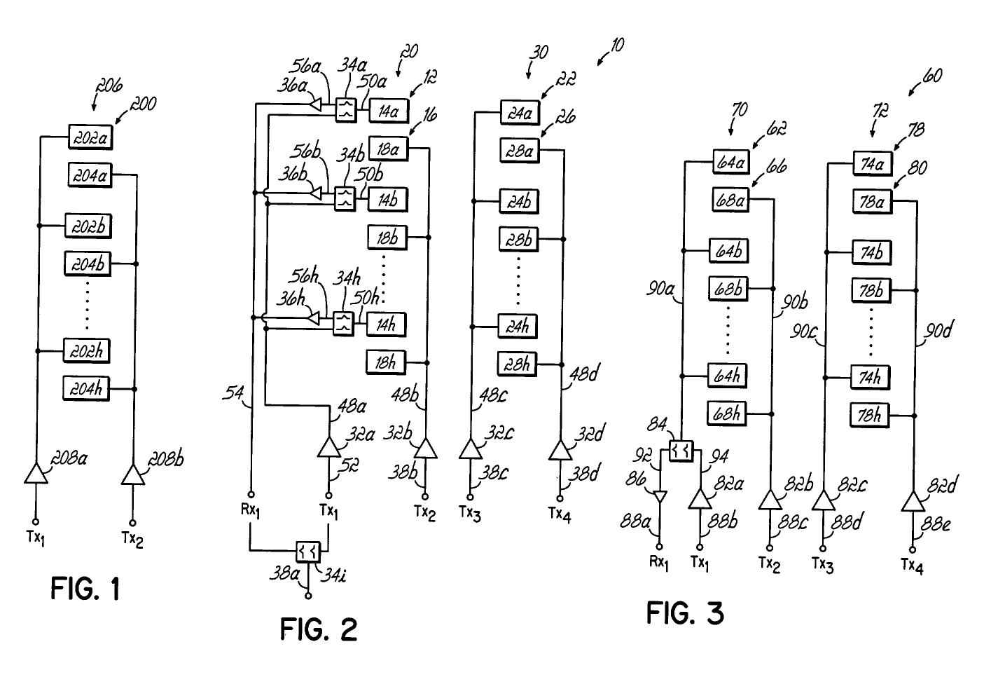

With reference to FIG. 1, there is shown a block diagram of an antenna 200 configured for free space combining in accordance with principles of the present invention. Antenna 200 comprises a first array of radiating elements 202a-h interleaved with a second array of radiating elements 204a-h and arranged in a column 206, each array of elements advantageously coupled to a respective amplifier 208a, 208b. As illustrated, radiating elements 202a-h, 204a-h are patch elements; however, those skilled in the art will appreciate that other types of elements, such as dipoles, cavity backed patches, etc., may be used without departing from the spirit of the present invention.

In operation, radiation from the first array of elements 202a-h combines with radiation from the second array of elements distant from column 206, or in free space. Thus, power radiated from the column 206 is the sum of the power from amplifiers 208a, 208b without any associated combining losses.

Embodiments of the present invention may advantageously include an array or column having duplexed transmit and receive channels. Further, embodiments of the present invention may also include multiple columns, with some or all of such columns including duplexed transmit and receive channels, and optionally configured to provide receive diversity. Embodiments of the present invention may also include one or more columns dedicated to receiving signals. Further, a column may be configured for three or more channels using additional interleaving. Moreover, channels within a column or columns may have differing numbers of radiating elements without departing from the spirit of the present invention.

FIGS. 2-5 further illustrate embodiments of the present invention containing several configurations for antennas having four transmit channels and one receive channel. As such, the embodiments of FIGS. 2-5 may resemble embodiments configured for migrating an existing GSM system to EDGE. Those skilled in the art will appreciated that other embodiments having differing numbers of transmit and receive channels, columns and/or interleaving of arrays are possible for present or future telecommunication systems having the same or other modulation schemes without departing form the spirit of the present invention.

Referring to FIG. 2, there is shown a second embodiment 10 of an antenna in accordance with the principles of the present invention. Antenna 10 is configured to support four transmit channels and one receive channel, indicated at reference numerals Tx₁₋₄ and Rx₁, respectively. As configured in FIG. 2, antenna 10 provides four cables 38a-d for interconnection. Antenna 10 is comprised of a first array 12 of radiating elements 14a-h interleaved with a second array 16 of radiating elements 18a-h arranged in a column 20. Antenna 10 further comprises a third array 22 of radiating elements 24a-h interleaved with a fourth array 26 of radiating elements 28a-h arranged in a column 30. Antenna 10 further comprises a plurality of single channel amplifiers 32a-d, a plurality of duplexers 34a-i, and a plurality of low noise amplifiers 36a-h.

As illustrated, transmit channel Tx₁ is defined by the electrical connection of cable 38a, duplexer 34i, cable 52, single channel power amplifier 32a, feed 48a, duplexers 34a-h, cables 50a-h, and radiating elements 14a-h. Conversely, as also illustrated, receive channel Rx₁ is defined by the electrical connection of radiating elements 14a-h, cables 50a-h, duplexers 34a-h, cables 56a-h, low noise amplifiers 36a-h, feed 54, duplexer 34i, and cable 38. The receive channel Rx₁ is configured as a distributed active receive antenna (DARA) by including low noise amplifiers 36a-h proximate elements 14a-h, respectively. Similarly, transmit channel Tx₂ is defined by the electrical connection of cable 38b, single channel power amplifier 32b, feed 48b, and radiating elements 18a-h.

Transmit channel Tx₃ is defined by the electrical connection of cable 38c, single channel power amplifier 32c, feed 48c, and radiating elements 24a-h. Likewise, transmit channel Tx₄ is defined by the electrical connection of cable 38d, single channel power amplifier 32d, feed 48d, and radiating elements 28a-h.

In operation, the radiation of elements 14a-h, consistent with transmit channel Tx₁, and the radiation of elements 18a-h, consistent with transmit channel Tx₂, combine at a distance from antenna 10 due to interleaving of the radiating elements 14a-h, 18a-h in arrays 12, 16 in column 20. In like manner, the radiation of elements 24a-h, consistent with transmit channel Tx₃, and the radiation of elements 28a-h, consistent with transmit channel Tx4, also combine at a distance from antenna 10 due to interleaving of the radiating elements 24a-h, 28a-h in arrays 22, 26 in column 30.

It is contemplated that two such antennas 10 wherein the radiating elements 14a-h, 18a-h, 24a-h, 28a-h are linearly polarized, as understood by one skilled in the art, be used per sector in migrating a GSM system, desiring four connections per antenna 10 to EDGE.

Referring now to FIG. 3, a third embodiment of an antenna 60 in accordance with the principles of the present invention is illustrated. Antenna 60 also supports four transmit channels and one receive channel, indicated at reference numerals Tx₁₋₄ and Rx₁. Antenna 60 provides five cables 88a-e for interconnection. Antenna 60 comprises a first array 62 of radiating elements 64a-h and a second array 66 of radiating elements 68a-h. The radiating elements 64a-h, 68a-h of the arrays 62, 66 are alternately positioned within a first column 70.

Antenna 60 further comprises a second column 72 of alternately positioned radiating elements 74a-h, 76a-h. Radiating elements 74a-h are electrically connected as a third array 78. Radiating elements 76a-h are electrically connected as a fourth array 80.

Antenna 60 also comprises a plurality of cables 88a-e, 92, 94, a plurality of single channel amplifiers 82a-d, a duplexer 84, a low noise amplifier 86, and a plurality of feed networks 90a-d.

In this embodiment 60, receive channel Rx₁ is defined by the electrical connection of radiating elements 64a-h, feed network 90a, duplexer 84, cable 92, low noise amplifier 86, and cable 88a. Transmit channel Tx₁ is defined by the electrical connection of cable 88b, single channel power amplifier 82a, cable 94, duplexer 84, feed network 90a, and radiating elements 64a-h. Transmit channel Tx₂ is defined by the electrical connection of cable 88c, single channel power amplifier 82b, feed network 90b, and radiating elements 68a-h. Transmit channel Tx₃ is defined by the electrical connection of cable 88d, single channel power amplifier 82c, feed network 90c, and radiating elements 74a-h. Tx₄ is defined by the electrical connection of cable 88e, single channel power amplifier 82d, feed network 90d, and radiating elements 76a-h.

In operation, the radiation of elements 64a-h and elements 68a-h combine at a distance from antenna 60 due to the alternate positioning within first column 70. The radiation of elements 74a-h and elements 76a-h also combine at a distance from antenna 60 due to alternate positioning within column 72.

Two such antennas 60 wherein the radiating elements 64a-h, 68a-h, 74a-h, 76a-h are linearly polarized may be used per sector in migrating a GSM system, desiring five connections per antenna 60, to EDGE, as appreciated by one skilled in the art.

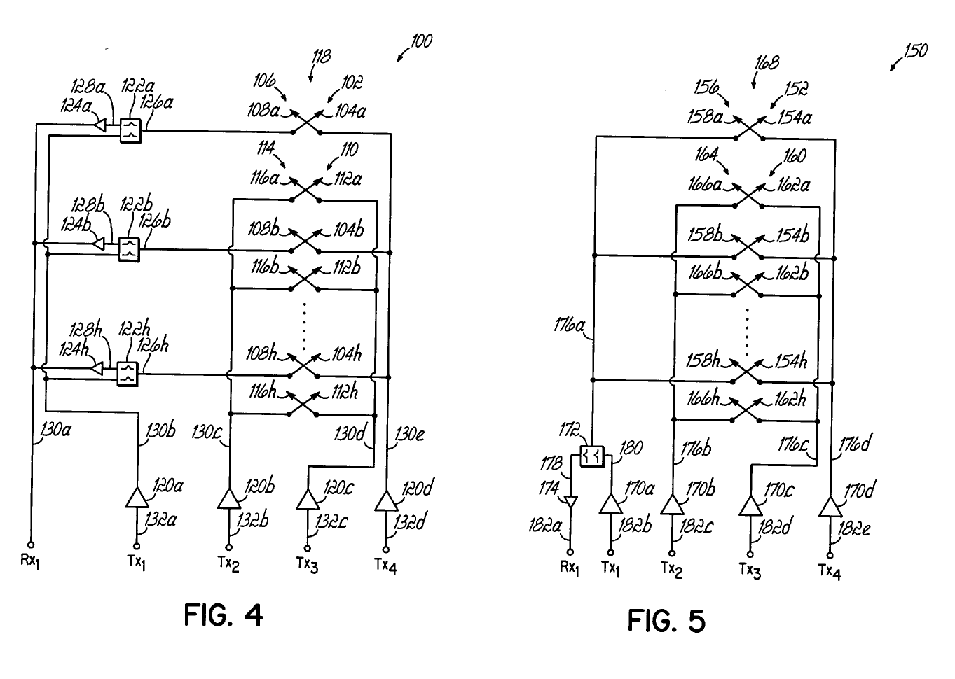

Referring to FIG. 4, a fourth embodiment of an antenna 100 having dual slant polarized elements, DARA, and five connections consistent with the present invention is presented. It is contemplated that one such antenna 100 may be used per sector in migrating a GSM system to EDGE, as will be appreciated by one skilled in the art.

Antenna 100 comprises a first array 102 of radiating elements 104a-h, a second array 106 of radiating elements 108a-h, a third array 110 of radiating elements 112a-h, and fourth array 114 of radiating elements 116a-h arranged in a column 118. Radiating elements 104a-h, oriented at 45 degrees with respective to column 118, intersect perpendicularly and respectively with elements 108a-h, also oriented at 45 degrees with respective to column 118. Likewise, elements 12a-h intersect with elements 16a-h. Elements 104a-h, 108a-h are interleaved, or alternately positioned, with elements 112a-h, 116a-h in a column 118. Thus, dual slant polarization of antenna 110 is provided. Antenna 100 further comprises a plurality of single channel amplifiers 120a-d, a plurality of duplexers 122a-h, and a plurality of low noise amplifiers 124a-h.

In antenna 118, receive channel Rx₁ is defined by the electrical connection of radiating elements 104a-h, cables 126a-h, duplexers 122a-h, cables 128a-h, low noise amplifiers 124a-h, and feed 130. The receive channel Rx₁ is configured as a distributed active receive antenna (DARA) by providing a low noise amplifiers 124a-h for each element 104a-h.

Transmit channel Tx₁ is defined by the electrical connection of cable 132a, single channel power amplifier 120a, feed 130b, duplexers 122a-h, cables 126a-h, and radiating elements 104a-h. Transmit channel Tx₂ is defined by the electrical connection of cable 132b, single channel power amplifier 120b, feed 130c, and radiating elements 112a-h.

Transmit channel Tx₃ is defined by the electrical connection of cable 132c, single channel power amplifier 120c, feed 130d, and radiating elements 116a-h. Similarly, transmit channel Tx₄ is defined by the electrical connection of cable 132d, single channel power amplifier 120d, feed 130e, and radiating elements 108a-h.

In operation, the cross polarized radiation of elements 104a-h, consistent with transmit channel Tx₁, and elements 108a-h, consistent with transmit channel Tx₄, combine with the cross polarized radiation of elements 112a-h, consistent with transmit channel Tx₂, and elements 116a-h, consistent with Tx₃, at a distance from antenna 118 due to interleaving of the radiating elements 14a-h, 18a-h in arrays 12, 16 in column 20. In like manner, the radiation of elements 24a-h, consistent with transmit channel Tx₃, and the radiation of elements 28a-h, consistent with transmit channel Tx₄, also combine at a distance from antenna 100 due to interleaving, or alternate positioning, of elements 104a-h, 108a-h and elements 112a-h, 116a-h in a column 118.

Referring now to FIG. 5, a fifth embodiment of an antenna 150 having dual slant polarized elements and five connections consistent with the present invention is presented. Antenna 150 may be used for a sector in migrating a GSM system to EDGE, as will be appreciated by one skilled in the art.

Antenna 150 comprises a first array 152 of radiating elements 154a-h, a second array 156 of radiating elements 158a-h, a third array 160 of radiating elements 162a-h, and fourth array 164 of radiating elements 166a-h arranged in a column 168.

Radiating elements 154a-h, oriented at 45 degrees with respective to column 168, intersect perpendicularly and respectively with elements 158a-h, also oriented at 45 degrees with respective to column 168. Elements 162a-h intersect with elements 166a-h, with respect to column 168, in a like manner. Elements 154a-h, 158a-h are interleaved, or alternately positioned, with elements 162a-h, 166a-h in a column 168. Thus, antenna 150 has dual slant polarization.

Antenna 150 further comprises a plurality of single channel amplifiers 170a-d, a duplexer 172, and a low noise amplifier 174. In antenna 158, receive channel Rx₁ is defined by elements 154a-h, duplexer 172, and low noise amplifier 174 interconnected by feed network 176, cables 178, 182a.

Transmit channel Tx₁ is defined by single channel power amplifier 170a, duplexers 172, and radiating elements 154a-h interconnected by cables 182b, 180 and feed network 176a. Transmit channel Tx₂ is defined the electrical connection of cable 182c, single channel power amplifier 170b, feed network 176b, and radiating elements 162a-h. Transmit channel Tx₃ is defined by the electrical connection of cable 182d, single channel power amplifier 170c, feed network 176c, and radiating elements 166a-h. Similarly, transmit channel TX₄ is defined by the electrical connection of cable 182e, single channel power amplifier 170d, feed network 176d, and radiating elements 158a-h.

In operation, the cross polarized radiation of elements 154a-h, consistent with transmit channel Tx₁, and elements 158a-h, consistent with transmit channel Tx₄, combine with the cross polarized radiation of elements 162a-h, consistent with transmit channel Tx₂, and elements 166a-h, consistent with Tx₃, at a distance from antenna 150 due to interleaving of the radiating elements 154a-h, 158a-h in arrays 152, 156 and elements 162a-h, 166a-h in column 168.

By virtue of the foregoing, there is thus provided an antenna that avoids the losses associated with combiners typically found in telecommunication systems. Such an antenna employs the principles of combining the radiation of interleaved elements in antenna arrays at a distance, far field, or in free space from the antenna. Such an antenna may also include single channel amplifiers.

While the present invention has been illustrated by the description of embodiments thereof, and while the embodiments have been described in considerable detail, it is not the intention of applicants to restrict or in any way limit the scope of the appended claims to such detail. Additional advantages and modifications will readily appear to those skilled in the art. It will be understood that the electrical connect to, from and between components such as low noise amplifiers, single channel power amplifiers, duplexers, and radiating elements may be accomplished using methods other than feeds, feed networks, or cables. Other methods include, but are not limited to: stripline, microstrip, hardlines, and etchings on circuit boards. It will also be understood that embodiments of the present invention are not limited to arrays of eight radiating elements. Rather, any number of interleaved or alternately positioned radiating elements may be used. Further, embodiments of the present invention are not limited to one receive channel and four transmit channels. An embodiment of the present invention could be constructed using any number of receive and transmit channels using the principles described herein. The invention in its broader aspects is therefore not limited to the specific details, representative apparatus and method, and illustrative examples shown and described. Accordingly, departures may be made from such details without departing from the spirit or scope of applicants' general inventive concept.

What is claimed is:

1. An antenna comprising:
a first array of radiating elements;
a second array of radiating elements;
a first power amplifier electrically coupled to the first array;
a second power amplifier electrically coupled to the second array;
wherein the radiating elements of the first array and the first amplifier define a first transmit channel, the radiating elements of the second array and the second amplifier define a second transmit channel, and the elements of the first array are interleaved with the radiating elements of the second array in a column so that radiation from the first array, associated with the first transmit channel, combines with radiation from the second array, associated with the second transmit channel, at a distance from the antenna.

2. The antenna of claim 1, wherein the elements are linearly polarized.

3. The antenna of claim 1, further comprising:
a duplexer coupled intermediate the first amplifier and at least one of the elements in the first array;
a low noise amplifier coupled to the duplexer;
wherein the first array of radiating elements, the duplexer, and the low noise amplifier define a receive channel.

4. The antenna of claim 3, further comprising:
a third array of radiating elements;
a fourth array of radiating elements;
a third power amplifier electrically coupled to the third array;
a fourth power amplifier electrically coupled to the fourth array;
wherein the radiating elements of the third array and the third amplifier define a third transmit channel, the radiating elements of the fourth array and the fourth amplifier define a fourth transmit channel, and the elements of the third array are interleaved with the radiating elements of the fourth array in a second column so that radiation from the third array, associated with the third transmit channel, combines with radiation from the fourth array, associated with the fourth transmit channel, at a distance from the antenna.

5. The antenna of claim 1, further comprising:
a third array of radiating elements;
a fourth array of radiating elements;
a third power amplifier electrically coupled to the third array;
a fourth power amplifier electrically coupled to the fourth array;
wherein the radiating elements of the third array and the third amplifier define a third transmit channel, the radiating elements of the fourth array and the fourth amplifier define a fourth transmit channel, and the elements of the third array intersect substantially orthogonally and respectively with elements of the first array and the elements of the fourth array intersect substantially orthogonally and respectively with elements of the second array.

6. The antenna of claim 1, further comprising:
a plurality of low noise amplifiers, each low noise amplifier located proximate an element in the first array;
a plurality of duplexers, each duplexer coupled intermediate an element in the first array and a low noise amplifier;
wherein the first array of radiating elements, the plurality of duplexers, and the plurality of low noise amplifiers define a distributed active receive antenna.

7. The antenna of claim 1, further comprising:
a duplexer coupled intermediate the first amplifier and the first array;
a low noise amplifier coupled to the duplexer;
wherein the first array, the duplexer, and the low noise amplifier define a receive channel.

8. The antenna of claim 1, wherein the radiating elements are patch elements.

9. The antenna of claim 1, wherein the radiating elements are dipole elements.

10. The antenna of claim 1, where in the amplifiers are single channel amplifiers.

11. An antenna comprising:
a first array of radiating elements;
a second array of radiating elements;
a third array of radiating elements;
a fourth array of radiating elements;
a first power amplifier electrically coupled to the first array;
a second power amplifier electrically coupled to the second array;
a third power amplifier electrically coupled to the third array;
a fourth power amplifier electrically coupled to the fourth array;
wherein the radiating elements are arranged in a column;
wherein the elements of the first array intersect substantially orthogonally and respectively with elements of the second array;
wherein the elements of the third array intersect substantially orthogonally and respectively with elements of the fourth array; and,
wherein the elements of the first and second arrays are interleaved with the elements of the third and fourth arrays so that radiation from the arrays forms dual slant polarization at a distance from the antenna.

12. The antenna of claim 11, wherein the first array and the first amplifier define a first transmit channel, the second array and the second amplifier define a second transmit channel, the third array and the third amplifier define a third transmit channel, and the fourth array and the fourth amplifier define a fourth transmit channel.

13. The antenna of claim 11, wherein the elements are dipole elements.

14. The antenna of claim 11, further comprising:
a duplexer, coupled intermediate the first amplifier and at least one of the elements in the first array;
a low noise amplifier coupled to the duplexer;
wherein the first array of radiating elements, the duplexer, and the low noise amplifier define a receive channel.

15. The antenna of claim 11, wherein the amplifiers are single channel amplifiers.

16. The antenna of claim 11, further comprising:
a plurality of low noise amplifiers, each low noise amplifier located proximate an element in the first array;
a plurality of duplexers, each duplexer coupled intermediate an element in the first array and a low noise amplifier;
wherein the first array of radiating elements, the plurality of duplexers, and the plurality of low noise amplifiers define a distributed active receive antenna.

17. The antenna of claim 11, further comprising:
a duplexer coupled intermediate the first amplifier and the first array;
a low noise amplifier couple to the duplexer;
wherein the first array, the duplexer, and the low noise amplifier define a a receive channel.

18. A method of transmitting a communications signal from an antenna comprising:
amplifying a first transmit signal using a first amplifier;
amplifying a second transmit signal using a second amplifier;
communicating the first transmit signal to a first array of radiating elements; and
communicating the second transmit signal to a second array of radiating elements;
wherein the radiating elements of the first array are interleaved with the radiating elements of the second array in a column so that radiation from the first array combines with radiation from the second array at a distance from the antenna.

19. The method of claim 18, further comprising:
receiving a receive signal using the first array;
communicating the receive signal to a low noise amplifier;
amplifying the receive signal using the low noise amplifier.

20. The method of claim 18, further comprising:
amplifying a third transmit signal using a third amplifier;
amplifying a fourth transmit signal using a fourth amplifier;
communicating the third transmit signal to a third array of radiating elements;
communicating the fourth transmit signal to a fourth array of radiating elements;
wherein the radiating elements of the third array are interleaved with the radiating elements of the fourth array in a second column so that radiation from the third array combines with radiation from the fourth array at a distance from the antenna.

21. The antenna of claim 18, further comprising:
amplifying a third transmit signal using a third amplifier;
amplifying a fourth transmit array signal using a fourth amplifier;
communicating the third transmit signal to a third array of radiating elements;
communicating the fourth transmit signal to a fourth array of radiating elements;
wherein the radiating elements of the third array and the third amplifier define a third transmit channel, the radiating elements of the fourth array and the fourth amplifier define a fourth transmit channel, and the elements of the third array intersect substantially orthogonally and respectively with elements of the first array and the elements of the fourth array intersect substantially orthogonally and respectively with elements of the second array.

22. A method of transmitting a communications signal from an antenna comprising:
amplifying a first transmit signal using a first amplifier;
amplifying a second transmit signal using a second amplifier;
amplifying a third transmit signal using a third amplifier;
amplifying a fourth transmit array signal using a fourth amplifier;
communicating the first transmit signal to a first array of radiating elements;
communicating the second transmit signal to a second array of radiating elements;
communicating the third transmit signal to a third array of radiating elements;
communicating the fourth transmit signal to a fourth array of radiating elements;
wherein the radiating elements are arranged in a column;
wherein the elements of the first array intersect substantially orthogonally and respectively with elements of the second array;
wherein the elements of the third array intersect substantially orthogonally and respectively with elements of the fourth array; and,
wherein the elements of the first and second arrays are interleaved with the elements of the third and fourth arrays so that radiation from the arrays forms dual slant polarization at a distance from the antenna.
